(19) United States
(12) Patent Application Publication
(10) Pub. No.: US 2020/0378728 A1
(43) Pub. Date: Dec. 3, 2020

(54) ONE-WAY VISION BALLISTIC SHIELDING

(71) Applicant: BDMP Inc., Golden, CO (US)

(72) Inventor: Bob DeCamp, Golden, CO (US)

(73) Assignee: BDMP Inc., Golden, CO (US)

(21) Appl. No.: 16/888,992

(22) Filed: Jun. 1, 2020

Related U.S. Application Data
(60) Provisional application No. 62/854,321, filed on May 30, 2019.

(51) Int. Cl. F41H 5/06; F41H 5/08; F41H 5/26; F41H 9/00; F41H 13/00; B44F 99/00; G08B 3/10

(52) U.S. Cl. CPC F41H 5/06; F41H 5/08; F41H 5/263; G08B 3/10; F41H 13/0025; B44F 99/00; F41H 9/00

(57) ABSTRACT

The present disclosure generally involves ballistic shields comprising handheld, mobile, and stationary partition embodiments that have features for one-way viewing such as one-way ballistic mirror and/or one-way vision graphics while blending into the environment and serving functional purposes. The ballistic shields may also have a variety of additional protective or combative features such as, but not limited to a blinding light system, pepper spray, gun ports, sirens, PA systems, remote communication systems, and medical equipment.

### CROSS REFERENCE TO RELATED APPLICATIONS

This application claims the benefit of U.S. Provisional Patent Application No. 62/854,321, filed on May 30, 2020, also titled “One-Way Vision Ballistic Shielding” which is incorporated by reference herein in its entirety for all purposes.

### BACKGROUND OF THE INVENTION

### 1. Field of the Invention

The present invention is in the technical field of ballistic shielding, specifically in the field of ballistic shielding for use in public places such as schools and churches.

### 2. Description of Related Art

Currently there is a problem with public shootings, often the perpetrator will enter a crowded area, such as a room, and start shooting people. In most public places there is nowhere for the victims to hide and bullets will pass through most standard furnishings. There is a need for places to hide that are bullet proof, mobile, and blend into the natural environment without reminding the people in those spaces that they are under threat of gun fire.

There are already handheld ballistic shields in the market that are used for crowd control such as riot shields and large metal vertical panels with wheels underneath them for indoor use; however, neither of these provide discrete solutions to providing public safety. Additionally, none of the available solutions allow for those using them to see through the ballistic shields to actively plan their next move or to fight back. The present invention solves these problems by providing ballistic shielding that is functional, blends into the natural surroundings, and allows the user to perceive and act against potential threats.

### SUMMARY

The scope of the present invention is defined solely by the appended claims and detailed description of a preferred embodiment and is not affected to any degree by the statements within this summary. The present disclosure generally involves ballistic shields comprising handheld, mobile, and stationary partition embodiments that have features for one-way viewing such as one-way ballistic mirror and/or one-way vision graphics while blending into the environment and serving functional purposes. The ballistic shields may also have a variety of additional protective or combative features such as, but not limited to a blinding light system, pepper spray, gun ports, sirens, PA systems, remote communication systems, and medical equipment. In embodiments of the ballistic shield partition the shield may also be used as a table.

### BRIEF DESCRIPTION OF THE DRAWINGS

Various embodiments are described herein with reference to the following Drawings Certain aspects of the Drawings are depicted in a simplified way for reason of clarity. Not all alternatives and options are shown in the Drawings and, therefore, the Claims are not limited in scope to the content of the Drawings.

### FIGURES

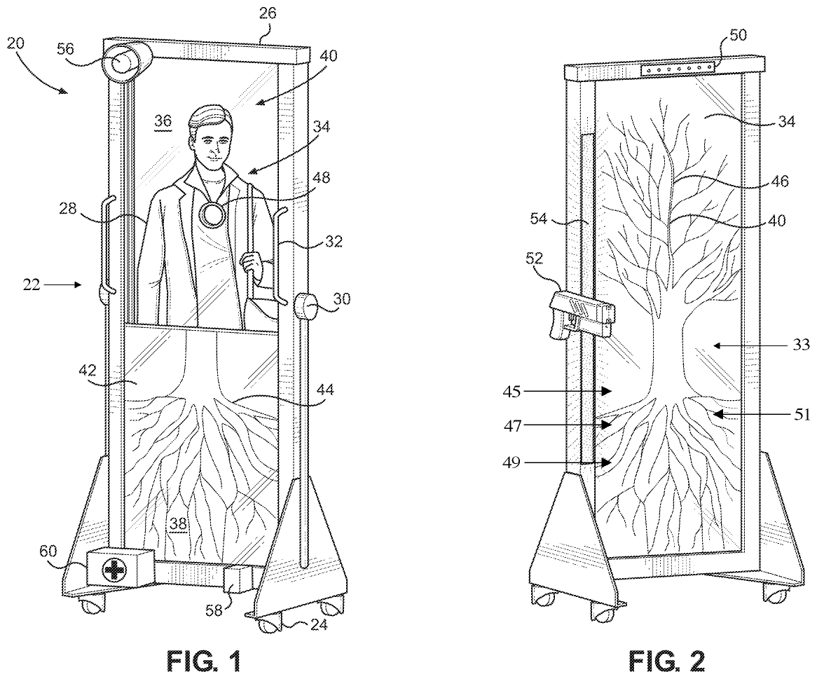

FIG. 1 illustrates a ballistic shield partition, in accordance with an embodiment of the present disclosure.

FIG. 2 illustrates a ballistic shield partition, in accordance with an embodiment of the present disclosure.

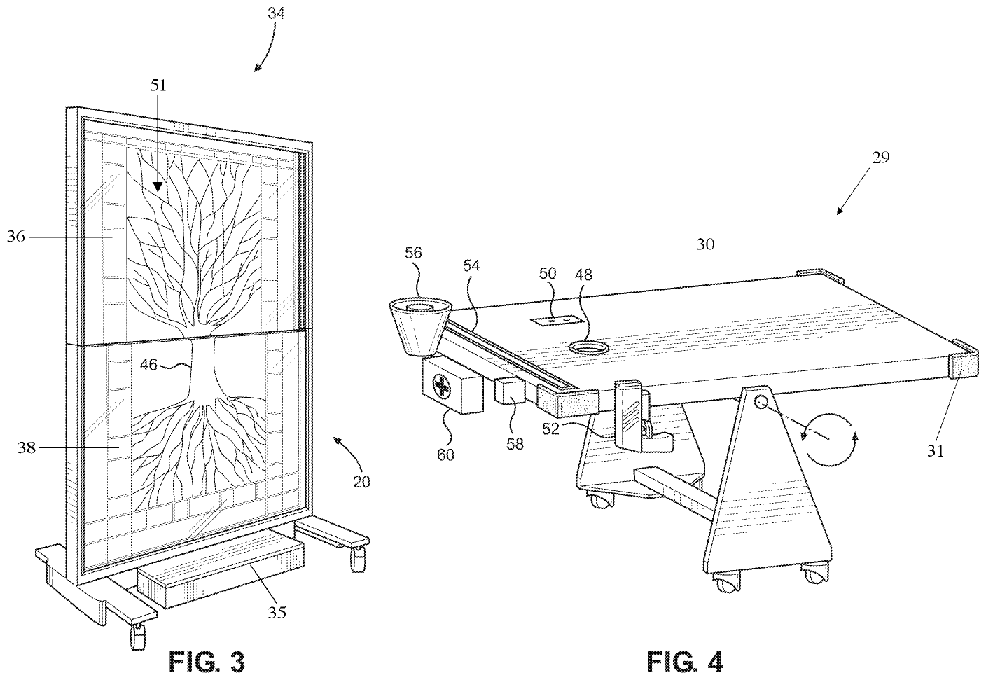

FIG. 3 illustrates a ballistic shield partition, in accordance with an embodiment of the present disclosure.

FIG. 4 illustrates a ballistic shield partition in table form, in accordance with an embodiment of the present disclosure.

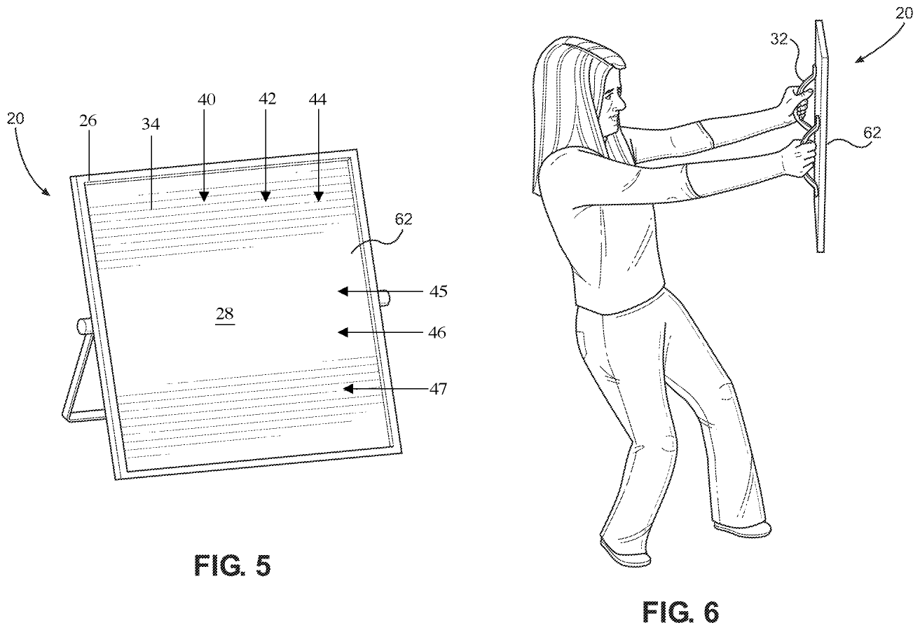

FIG. 5 illustrates a ballistic shield, in accordance with an embodiment of the present disclosure.

FIG. 6 illustrates a ballistic shield in use, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment, are often not depicted in order to facilitate a less obstructed view of these various embodiments of the present disclosure.

### 2. REFERENCES

20 Ballistic Shield
22 Ballistic Shield Partition
24 Wheels
26 Frame
28 Body
29 Table
30 Hinges
31 Padding
32 Handles
33 Ballistic Glass
34 Transparent Ballistic Resistant Material
35 Storage
36 Top Portion of Partition
38 Bottom Portion of Partition
40 One-Way Ballistic Mirror
42 Surface Treatment
44 Graphic
45 Whiteboard
46 One-way Vision Graphic
47 Tack Board
48 Gun Port
49 Magnetic Surface
50 Pepper Spray
51 Perforated Vinyl
52 Taser
54 Blinding Light Source
56 PA and Siren System
58 Remote Communication Systems
60 Medical Equipment
62 Hand-Held Ballistic Shield

### DETAILED DESCRIPTION

The following description is not to be taken in a limiting sense but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same. Generally, ballistic shielding as described is intended for use in pubic spaces where there is a risk of gun violence. The ballistic shielding is intended to provide a measure of safety by providing a defensive measure potential victims can hide behind to avoid gunfire; and perhaps more effectively, a safe space from where the user can observe the attacker and decide what action to take when split second decisions can make the difference between life and death. The shielding may also comprise effective countermeasure to disrupt or incapacitate a potential attacker. These features are particularly important to law enforcement and security personnel who often stand unknowingly in harms way and are the most capable of repelling an attack before further victims are injured by providing them with a safe space from which to mount a counterattack. Obvious places for the use of the shielding include schools, churches, public buildings, event centers, sporting arenas, and any number of public spaces where gun violence is more likely to occur.

FIG. 1 illustrates an embodiment of one such ballistic shield (20). In this embodiment the ballistic shield is shaped like a partition (22). The partition may be shorter; but, is preferably the full average height of a grown adult and wide enough to provide protection for one or more people. In one preferred embodiment, the partition (22) is approximately 48″ wide by 76″ tall, in another smaller and more mobile embodiment the partition is 24″ wide and 51″ tall. Obviously, the ballistic shield can be made in a variety of shapes and sizes suitable for its environment.

The partition may be bullet proof and as such may be quite heavy, in order to assist in its movement, the partition (22) may have one or more wheels or lockable casters attached to its base (24). The frame (26) may have a fixed or removable body (28), and both the frame and body of the partition may be comprised of any bulletproof material suitable to its purpose. Common materials would be metals, ceramics, composites, carbon fiber, Kevlar, nylon; or ideally, ballistic glass (33) commonly known as bullet proof glass. As seen in FIG. 4, the partition could also be configured with hinges (30) along the frame so that the panel could be locked parallel to the floor forming a table (29) with one or more upright supports. In the table (29) formation, the partition could also work well as an earthquake shelter. The hinges (30) could also allow for the partition (22) to be locked in an upside-down position. The partition may also comprise handles (32) so that it may easily be moved and padding (31) along its frame (26) to prevent injury to a user should they bump into it or if it falls onto a user, which is important because of the partition's great weight. The partition may also have integrated storage (35), such as lockable boxes for the storage of weapons or medical supplies. The partition may also comprise fasteners for assembling and disassembling the partition without using tools. The partition may also comprise a supplemental armor strip for gap protection when connecting multiple units together.

In a preferred embodiment, shown in FIGS. 1 and 2 (the same embodiment), the body (28) of a ballistic shield partition (22) may comprise a transparent ballistic resistant material (34). This material may comprise the entirety of the body (28) of the partition (22) or just a portion of the partition. In a preferred embodiment, a transparent ballistic resistant material (34) comprises the upper portion of the body of the partition (36), in this way a user may see through the top portion of the partition (36), while the bottom portion (38) of the partition may be made out of a non-transparent material.

In another embodiment, as seen in FIG. 3, the upper (36) transparent ballistic resistant material (34) may slide down into the bottom (38) portion of the body (28) of the partition and lock into place allowing the partition to have an adjustable height and to allow for ease of storage and shipment. In another embodiment, the transparent ballistic resistant material (34) can be one-way ballistic mirror glass (40) commonly called mirrored bullet proof glass, allowing the user to see an assailant, while an assailant would only see a mirror.

As seen in FIGS. 1, 2, and 3; the partition (22) may have a surface treatment (42) to hide the ballistic resistant nature of the shield or simply for aesthetic purposes, making the partition less bellicose and more harmonious with its surroundings. A few examples of possible surface treatments could comprise: a wood veneer, a pin board, a chalkboard, a white board, or a projector screen. Alternatively, the surface treatment (42) could be a graphic (44) printed on the partition displaying anything the user desires, or a combination of a graphic (44) and another surface treatment (42). The surface treatment could also be a whiteboard (45), tack board (47), or a magnetic surface (49).

Where the partition (22) is made of transparent materials the surface treatment could allow for one directional transparency similar to, better than, or in conjunction with one-way glass, allowing the user to see an assailant, while protecting the user from being seen by an assailant. One example of such a surface treatment (42) would be a one-way vision graphic (46). A one-way vision graphic can be made several ways, or combination of ways. For example, the surface facing the potential threat can be covered by a graphic printed on perforated vinyl (51), allowing the user behind the partition to see an assailant in front of the partition while the assailant is unable to see the user. FIG. 3 shows a one-way vision graphic (46) applied to the entire surface of the body of a partition made of transparent ballistic resistant materials (34), in this case mirrored ballistic glass (40). In a preferred embodiment, this surface treatment would be applied just to the upper portion (36) of the body (28) of the partition (22).

As seen in FIGS. 1 and 2; various embodiments of a ballistic shield (20) may also comprise various additional protective features, such as: guns, a gun port (48), pepper spray (50), a Taser (52), a blinding light source (54), such as high powered LEDS, smoke bombs; PA and siren system (56); in addition to more practical features, such as: medical equipment (58); remote communication systems (60), such as cell phones or radio transmitters; batteries, power cords, and the like.

Another embodiment of a ballistic shield is shown FIG. 5. This hand-held version of a ballistic shield (62) is small enough to sit on a desk. In a preferred embodiment this shield may be approximately 12″ wide by 16″ tall, which is enough to cover the face and chest of an adult user as shown in FIG. 5. The hand-held embodiment (62) may have handles (32), may be made of a solid bullet proof material, such as steel or a transparent ballistic resistant material (34) and/or one-way vision graphics (46) used in the panel versions of the ballistic shield (20). The hand-held version of a ballistic shield (62) can be made with a graphic displaying anything the user desires or look like a whiteboard (45), tack board (47), or a magnetic surface (49).

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A ballistic shield, comprising:
a body with a front side and a back side;
transparent ballistic materials; and
a one-way vision graphic applied to said transparent ballistic materials, wherein a user can see through the transparent ballistic material and one-way vision graphic from one side of the ballistic shield and not from the other.

2. The ballistic shield of claim 1, wherein said transparent ballistic material is one-way ballistic mirrored glass.

3. The ballistic shield of claim 1, wherein said transparent ballistic material is one-way ballistic mirrored glass and said one-way vision graphic is perforated vinyl.

4. The ballistic shield of claim 1, wherein said one-way vision graphic is perforated vinyl.

5. The ballistic shield of claim 1, wherein said one-way vision graphic is wood veneer.

6. The ballistic shield of claim 1, wherein said one-way vision graphic is white board.

7. The ballistic shield of claim 1, wherein said one-way vision graphic is tack board.

8. The ballistic shield of claim 1, wherein said one-way vision graphic is a magnetic surface.

9. The ballistic shield of claim 1, wherein said ballistic shield is a partition with a top portion and a bottom portion and is tall enough and wide enough to shield a person standing up.

10. The ballistic shield of claim 9, wherein said partition comprises transparent ballistic materials in the top portion and non-transparent ballistic materials in the bottom portion.

11. The ballistic shield of claim 9, wherein said top portion of said partition may slide down into the bottom portion.

12. The ballistic shield of claim 9, wherein said partition may have hinges and locked parallel to the floor and used as a table or bomb shelter.

13. The ballistic shield of claim 9, wherein said partition has handles and wheels.

14. The ballistic shield of claim 1, further comprising a gun port.

15. The ballistic shield of claim 1, further comprising high powered LEDs.

16. The ballistic shield of claim 1, further comprising a PA and siren system.

17. The ballistic shield of claim 1, further comprising pepper spray.

18. The ballistic shield of claim 1, further comprising a taser.

19. The ballistic shield of claim 1, further comprising remote communication systems.

20. The ballistic shield of claim 1, wherein said ballistic shield is handheld and large enough to protect the head and chest of a user.
